(19) United States
(12) Patent Application Publication
(10) Pub. No.: US 2007/0276729 A1
(43) Pub. Date: Nov. 29, 2007

(54) System and method for advertising

(76) Inventor: Carl Freer, Los Angeles, CA (US)

Correspondence Address: MORRISON & FOERSTER, LLP, 555 WEST FIFTH STREET, SUITE 3500, LOS ANGELES, CA, 90013-1024, US

(21) Appl. No.: 11/503,730

(22) Filed: Aug. 11, 2006

Related U.S. Application Data
(60) Provisional application No. 60/808,805, filed on May 26, 2006.

(51) Int. Cl. G06Q 30/00

(52) U.S. Cl. 705/14

(57) ABSTRACT

The present invention is directed to method and system for presenting advertisement messages, marketing surveys, invitation to instant offers, interactive media, or electronic voucher to a user of a remote communication device, such as a cellular telephone or a television set top box. In accordance with the preferred embodiments of the present invention, executable multimedia files are transmitted to one or more remote devices (e.g., a mobile phone), which is caused to execute the multimedia files either upon receiving the file or at a later time. Upon execution of the multimedia file, a user is prompted to interact with the remote device (e.g., by pressing one ore more buttons on a phone), preferably within a specified time period. Upon receiving input signals from the user, a notification signal is generated and transmitted by the remote device.

### CROSS-REFERENCE TO RELATED APPLICATIONS

The present invention claims the benefit under 35 USC 119(e) of U.S. provisional patent application Ser. No. 60/808,805 filed May 26, 2006, the contents of which are incorporated by reference herein.

### BACKGROUND

1. Field of Invention

The present invention relates to systems and methods for advertising. In particular, the present invention relates to presenting and tracking the consumption of audio and/or visual content to a remote device, such as a mobile phone or television set top box.

2. Description of Related Art

Conventional methods for delivering advertisement messages typically involve sending messages to mass markets. This is typically described as the “Spray and Pray” approach, whereby this information is delivered to a wide audience in the hope that it is received by sufficient number of targeted consumers with demographic profiles that make them ideal targets of the advertisements. An example or convention mass marketing strategy is the delivery of video advertising through television channels. Although an advertiser may take steps to ensure that their message is delivered via channels that traditionally are expected to contain a significant concentration of consumers in their target demographic, they nevertheless have little or no means to accurately monitor or measure, on a qualitative or quantitative basis, the effectiveness of such an approach.

Although methods exist to roughly estimate the effectiveness of a marketing campaign such as auditing subsequent purchasing behavior or sample consumer surveys, numerous factors affect consumers making it nearly impossible to directly measure the cause and effect of a specific campaign. Furthermore, advertisers are required to pay, often in advance of advertisement transmission, a sum proportional to the number of individuals expected to be in a position to observe the advertising, regardless of whether those individuals observe the advertising or not.

Recently, new consumer electronic technologies such as personal video recorders (e.g., digital video recorders) that enabled the skipping of advertisement messages further reduce the effectiveness of traditional forms of advertising, resulting in an even higher cost per successful hit.

On the other hand, direct mailing campaigns are considered to be more accurate in delivering marketing information to targeted individuals or groups. However, the cost of mail delivery is significantly higher than television, radio or print advertising and still does not guarantee consumption by recipient as there is a high probability that the information is discarded before it is reviewed.

Methods also exist for advertisers to take advantage of the nature of the Internet and the functionality of a web browser by delivering marketing information in various forms. A typical form of Internet advertising involves “Banner Ads” having embedded within a hypertext link for directing the user who clicks on the banner ads to the advertiser's website. Typically, the advertiser is expected to “pay per click” each time a banner advertisement is viewed and responded to by a consumer. The banner advertisement has many disadvantages. First, little is known about the profile of the individuals who click on an ad, other than the context of the web page on which the ad was placed. Furthermore, in order to minimize the obtrusiveness of the ad, it is substantially limited both in physical size and download payload.

The vast majority of the advertising delivered today comprises passive marketing messages that require no immediate participative response from an individual who views the messages and existing response mechanisms such as those outlined above are both inappropriate and ineffective. There exists a need for more effectively targeting and delivering advertisement messages to the consumer base. Furthermore, advertisers would benefit from receiving immediate feedback as to when and to whom the advertisement messages reached. More specifically, there is a need for a means to accurately monitor and measure the acceptance of marketing information such that the advertiser may elect to pay for only the advertisement messages that were observed by individuals within a target demographic.

### SUMMARY OF THE PRESENT INVENTION

It is an object of the present invention to provide a solution to the needs identified above by providing reliable means for delivering advertisement media to targeted recipients and for verifying that advertisements delivered are suitably consumed. The present invention may be embodied in various forms for enabling individuals to provide qualitative feedback on their impression of the relevance and/or interest in the advertisement message and/or product being advertised, provide responses to survey questions included in the advertisement, request further information, adapt their profile and/or ultimately allow for immediate purchase of an advertised product as a direct response to the advertisement message.

The present invention in accordance with a preferred embodiment is operated within the environment of mobile telecommunication network comprising of a one or more network operators, and a plurality of two-way mobile communication devices (e.g., mobile phones) capable of receiving and playing back multimedia content.

The present invention provides the ability for an individual associated with a remote device (e.g., a user of a mobile telephone) to perform a physical action (e.g., to commence playback of a multimedia advertisement file), and a further physical action of interacting with the advertisement message either during the presentation of the advertisement or within a limited time following the full presentation. The present invention operates on an educated assumption that, if there is interactivity with the advertisement on the part of the individual who received the advertisement, there is a higher probability that the individual was present throughout the presentation and thus the advertisement was more effectively delivered and received.

In accordance with a preferred embodiment of the invention, a method is provided for indicating to a user of a remote device that an advertising message is available for viewing on the remote device. The user is offered a method to interact with the advertisement such as clicking a button to initiate a display of the message. Following the display of such message, a further option is offered to the user to indicate that the message has been viewed by the user. The ‘message viewed’ response from the user may cause the remote device to log into a database that the message has been viewed, and transmit such information from the remote device to another remote device such as a central server (either immediately or at some time in the future) so that an advertiser may receive an audited record that the message has been received and viewed. The ‘message viewed’ mechanism is particularly relevant where the advertising message is presented in the form of a brief video or other graphical sequence such as the typical 30 second adverts commonly delivered for television viewing. The information that is logged by the remote device may include the time, location and various other details that further enhance the qualitative information delivered to the advertiser; the information may be later transmitted by the remote device to the central server or to any destination designated by the wireless network operator.

In accordance with the preferred embodiment, a countdown timer may be initiated following the end of the message during which the user must take action in order for the ‘message viewed’ mechanism to be valid.

In accordance with an alternative embodiment of the invention, in order to persuade an individual user of a remote device to view the message and subsequently trigger the ‘message viewed’ action, the present invention provides for some reward to be awarded to the user as a result. For example, in the case that the remote device comprises a mobile phone, the reward could be issued in the form of airtime credit automatically added to that user's account upon receiving the ‘message viewed’ confirmation.

In accordance with another embodiment of the present invention, a remote user may be asked to respond to an inquiry relevant to the content of the advertisement they have just viewed. While there are many ways by which such an enquiry can be presented, limited only by the creativity of the advertiser, some examples include the display of a numeric or alphanumeric code at some point in the presentation that would need to be entered by the user of the remote device following the presentation to indicate that the ad has been viewed to claim their reward if such is offered. Other examples include presenting questions regarding the color of a vehicle shown in the presentation, or even the presentation of two or more images, some of which are relevant to the presentation and some that aren't and require the user to select a valid one.

In accordance with yet another embodiment of the present invention, the user of the remote device may be enabled to respond in such a way as to indicate a degree of relevance, interest or emotional response to the advertisement they have just viewed. This could be in the form of a ‘thumbs-up/thumbs-down’ or some form of sliding scale such as ‘press 1-3’ to indicate level of interest where ‘1’ is ‘no interest’ and ‘3’ is ‘very interested’.

In accordance with other embodiments of the present invention, the user may be asked, or may optionally, interact with the media while the media is being replayed.

### BRIEF DESCRIPTION OF THE DRAWINGS

FIG. 1 is a schematic diagram illustrating the various different embodiments of the present invention;

FIG. 2 is a schematic diagram illustrating a method of advertisement media delivery in accordance with the preferred embodiment of the invention;

FIG. 3 is a schematic diagram illustrating a method of market research in accordance with an alternative embodiment of the present invention;

FIG. 4 is a schematic diagram illustrating a method of marketing in accordance with another alternative embodiment of the present invention;

FIG. 5 is a schematic diagram illustrating a method of advertisement delivery in accordance with yet another alternative embodiment of the present invention.

### DETAILED DESCRIPTION OF THE EMBODIMENTS

The various embodiments of the present invention will now be described with references to FIGS. 1-5.

As shown in FIG. 1, the present invention may be implemented in various different ways, either separately or in combination. Specifically, the present invention may be used for delivery of advertisement media with a request for confirmation 10, market research 30, direct response advertisements (i.e., “instant offers”) 50, and/or delivery of interactive advertisement media 70. Each embodiment is described in detail below.

1. Confirmed Delivery of Advertisement Media

In accordance with the preferred embodiment, advertising media, such as a video file, is delivered (via broadcast, multicast, or unicast) to a remote device (e.g., a mobile phone) from a network operator or an advertiser. The user of the remote device may choose to replay the received advertising media upon receiving the media, or choose to store the received media for later replay. Upon replay of the media on the remote device, the user is asked to confirm the consumption (i.e., viewing or listening) of the media, after which an advertisement viewed notification is generated by the remote device. The method of confirming the consumption may take one of a variety of forms. FIG. 2 illustrates a schematic diagram of the various possible implementations for confirming the consumption of advertisement media in accordance with a preferred embodiment of the present invention.

Specifically, as shown in FIG. 2, after the media is replayed, a countdown clock 11 may be displayed on the remote device; the countdown clock may display a graphical clock that “counts down” from a predetermined period of time (e.g., ten seconds), during which the user must take an action, such as clicking a button on the remote device, to confirm the consumption of the advertising media. The countdown clock 11 may take the form of an animated clock 14, which may displaying the counting down of numbers in a variety of ways, the displaying of the numbers being counted down being considered a generic countdown 20. Alternatively, the clock may count up 21 rather than down. The clock itself may be graphically designed so as to display an advertisement brand (a “branded clock” 22), or alternatively with a logo 23. For instance, the clock may take the form of a Pepsi logo, with numerical countdown or count up being displayed at the center of the Pepsi logo.

As an alternative to the countdown clock, other time-sensitive methods of confirmation of media consumption may be used, such as a disappearing graphical button 15 to be clicked; the button may be a flashing button 19 on a screen of the remote device, and may graphically indicate on/off status 18. As another alternative to the countdown clock, a vanishing advertisement 16 may be used as a substitute; the user needing to take certain action using the remote device before the media completely vanishes or fades 17. The “clock” may be displayed in other forms of expiring metering mechanism, such as a disappearing progress bar of an emptying bottle, or a ticking device.

Other variations to the countdown clock for confirming the viewing/listening of the media may include asking the user to enter a code 12 that may have been displayed or audibly sounded either during the replay of the media or at the end of the media. In this instance, the code may take the form of a number that is displayed after the replay of the media, a number that may be displayed or voiced, or even asking the user to select/enter a color that may have been the dominant theme of the media.

As another alternative to the countdown for confirming the viewing/listening of the media, the user can be asked to take action while the media is being replayed (“click action during the media replay” 13), which may be prompted to the user in the form of generating a graphical display that states “click now!” 25, or asking the user to take action when a logo appears 24. The user interaction may also be randomly selected 26. In accordance with one embodiment of the present invention, in response to user interaction with the media replayed, the advertiser and/or the network operator may offer to the user a random gift 27 (or a chance to win a random gift), including random cash prizes. In such an instance, the timing by which the user interacts with the media (or “clicks”) may be recorded 29 and later transmitted to the advertiser and/or network operator so as to verify that a prize is indeed won.

In accordance with the preferred embodiment, which ever method of implementation discussed above is used, upon confirmation of the media being consumed by a user, a signal or a message may be generated by the remote device and sent to the advertiser and/or the network operator. The confirmation may be sent immediately upon the user confirming the media being consumed, or at a later time when the remote device is otherwise inactive.

It is envisioned that the users of remote devices may be motivated to consume and confirm the advertising media received via a variety of possible incentive programs, such as offering of free airtime on a mobile telephone, cash prizes, accumulation of points or other measures of commodity that may be used to redeem goods and/or services at a later time. The numerous possibilities of incentives is not discussed in detail in this application, but is well contemplated as within the scope of the present invention.

In accordance with another embodiment of the present invention, a plurality of advertising media may be received and stored for replay. The user of the remote device may choose to replay all of the media received sequentially, or simply to consume one at a time, upon moments of convenience.

2. Market Research

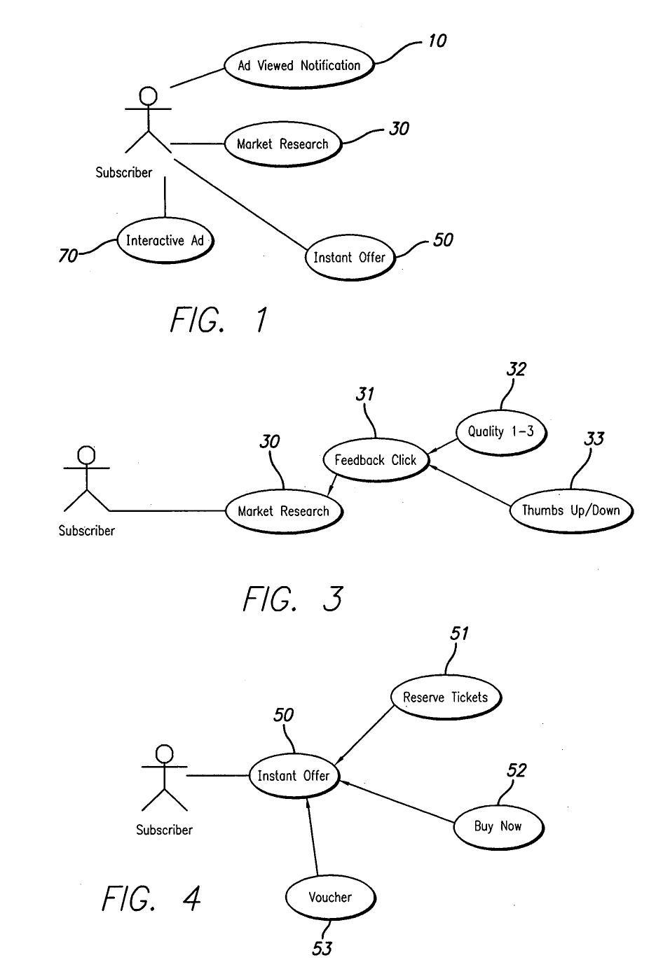

In accordance with an alternative embodiment of the present invention, rather than sending advertising media to the remote devices, a survey for purposes of market research may be sent to the remote devices. FIG. 3 is illustrative of the market research application 30 in accordance with the alternative embodiment. Specifically, rather than using a confirmation implementation such as described above, a user may be asked to provide feedback 31, such as the quality of the product/service/message that was the subject of the marketing research 32, or simply an approval or disapproval 33 of the product/service/message that was the subject of the marketing research.

It is noted that the market research or survey media may be delivered either independently of in conjunction with an advertising media.

3. Instant Offers

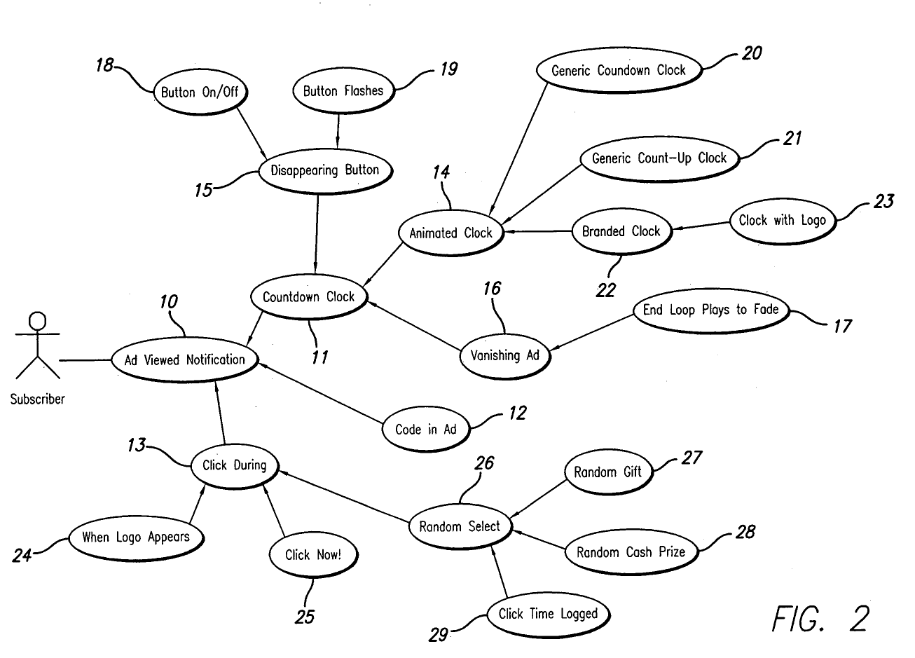

In accordance with yet another alternative embodiment of the present application, the advertising media delivered may be used as a conduit for offering to users instant offers 50. For instance, as shown in FIG. 4, during or after the replay of a media, the user may be presented with the option of reserving tickets 51 to an advertised event, to purchase goods or services 52 that were the subject of the media, or be given a voucher 53 for later redemption. Upon acceptance of any such offers (via interaction by the user, such as clicking one or more buttons on a mobile telephone), the remote device may be programmed to generate a signal to be sent back to the advertiser and/or the network operator, either immediately or at a later time.

4. Interactive Advertising Media

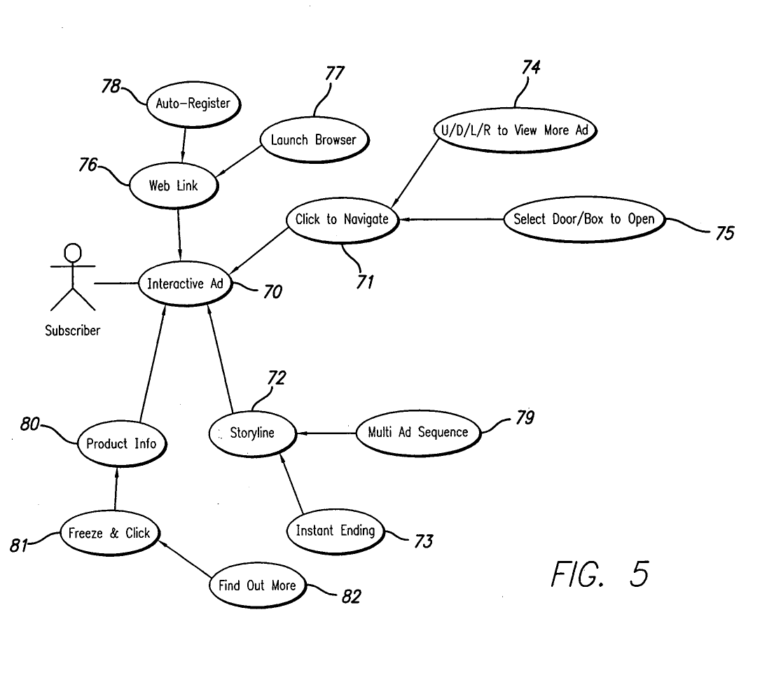

In accordance with yet another embodiment of the present invention, the advertising media delivered may be interactive in nature, requiring one or multiple actions on the part of the user. For instance, as shown in FIG. 5, an interactive advertisement 70 may take the form of a product info 80 being displayed in a running fashion, during which the user may pause (or “freeze and click”) 81 the media and ask to find out additional details about a particular aspect of the product 82. In another implementation, the interactive media may take the form of a storyline movie or soundtrack 72, during which there may be multiple advertisement sequence 79, and during which the user may be requested to interact with the advertisement to effect alternative endings to the storyline, or instant ending to the storyline 73. In yet another implementation, the interactive media may contain a variety of links 71 available for a user to select and navigate, such as clicking on a link to view more advertisement 74, or play games such as selecting a door/box to open to reveal possibly prizes inside 75. Yet another implementation may include simply a web link 76 that, upon activation by the user, may launch a browser 77 opening a webpage, or may allow the user to automatically register 78 for certain promotional programs.

The above embodiments of the present invention are provided as illustrative examples of the present invention and are not intended to restrict the scope of the present invention to the particularities described herein. It is contemplated that there are many other possible embodiments and implementations of the present invention. Therefore, it must be understood that the illustrated embodiment has been set forth only for the purposes of example and that it should not be taken as limiting the invention as defined by the following claims. For instance, while the present application uses mobile telephones as examples of remote devices, it is contemplated that other remote devices, such as television set top boxes, may also provide an environment in which the present application may be implemented.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

What I claim:

1. A method of presenting advertisement to a remote device, said remote device having a display and a user interface, said method comprising the steps of:
sending, to the remote device, an media file, said media file including content data, said content file including at least one of video data, graphics data, and audio data;
receiving, from said remote device, a notification signal, said notification signal indicating that said media file has been executed on said remote device,
wherein said notification signal is generated by said remote device upon said remote device receiving from a user of said remote device an input signal.

2. The method of claim 1, wherein said notification signal further indicating one of time and date on which said content file was presented on said remote device.

3. The method of claim 1, wherein said notification signal is sent only if said input signal is received from the user within a predetermined period of time following the presentation of said content data.

4. The method of claim 1, wherein said content file is one of an advertisement presentation, marketing survey, invitation to an offer, interactive media, and an electronic voucher for purchase of goods or services.

5. The method of claim 4, further comprising the step of, if the content file is one of a marketing survey, interactive media, or invitation to an offer, receiving from said remote device a user response to the marketing survey, interactive media, or the invitation to an offer.

6. The method of claim 1, wherein said remote device is one of a mobile communication device and a television receiver.

7. The method of claim 1, wherein said media file includes multimedia countdown data, said multimedia countdown data containing executable instructions for causing said remote device to indicate to the user of said remote device an expiring time period during which input signal from the user is to be received in order to generate said notification signal.

8. The method of claim 1, further comprising the step of providing one of free mobile communication airtime and monetary credits to an account of the user of the remote device upon receiving the notification signal.

9. The method of claim 1, wherein the notification signal is received from the remote device immediately after the remote device receives said input signal from the user.

10. The method of claim 1, wherein the notification signal includes a location information, said location information indicating a location of the remote device at which the content file was presented.

11. The method of claim 1,
wherein the media file includes code data that includes graphical data, said graphical data causing the remote device to display a graphical image representing one of an alpha, a numerical, and an alphanumerical code,
wherein the notification signal is sent only if the user code received from the user matches the code displayed in the graphical image.

12. The method of claim 1,
wherein the media file includes code data for causing the remote device to generate an audio sound, said audio sound reciting one of an alpha, a numerical, and an alphanumerical code,
wherein the notification signal is sent only if the user code received from the user matches the code displayed in the graphical image.

13. The method of claim 11 wherein said graphical image is displayed upon the completion of the presentation of the content file.

14. The method of claim 12, wherein said audio sound is presented upon the completion of the presentation of the content file.

15. The method of claim 1, further comprising the step of re-transmitting the notification signal to one of an advertiser and a network operator.

16. The method of claim 1, wherein said media file further includes presentation timing data, said presentation timing data causing the content file to be presented on the remote device at a designated time.

17. The method of claim 1, further comprising the steps of, upon receiving the notification signal from the remote device, send to the remote device a second media file for presentation on the remote device, said second media file including second content data comprising one of video data, graphics data, and audio data.

18. The method of claim 16, wherein said second content file, when presented, offers to the user of the remote device an option to purchase one of goods and services.

19. The method of claim 16, wherein the second media file includes one of voucher or coupon information.

20. The method of claim 16, wherein the second media file is sent immediately upon receiving the notification signal from the remote device.

21. The method of claim 1, further comprising the step of, upon receiving the notification signal from the remote device, automatically register the identification of the remote device to a third party.

22. The method of claim 1, wherein the media file is sent to the remote device over a wireless network.

23. The method of claim 1, wherein the media file is sent to the remote device over the Internet upon detection of the remote device being connected to the Internet.

24. The method of claim 1, wherein the media file includes at least one network address that is selectable during the presentation of the content file on the remote device.

25. The method of claim 24, wherein the selection of said at least one network address causes the remote device to automatically launch an Internet browser software that is already installed on the remote device.

26. The method of claim 24, wherein said network address is a hypertext link.

27. The method of claim 1, wherein the presentation of said content file is interruptible upon receiving an interrupt signal.

28. The method of claim 27, wherein said interrupt signal is a pause signal.

29. The method of claim 1,
wherein said media file further includes alternative content ending file and choice inquiry data,
wherein, at a predetermined point during which the content file is presented, the presentation of the content file is automatically interrupted, and the choice inquiry data causes the remote device to present an inquiry to the user of the remote device,
wherein, upon receiving from the user a choice signal, the media file causes the remote device to present the alternative content ending file, said alternative content ending file including one of video data, graphics data, and audio data.

30. A machine readable medium contain a set of executable instructions for causing a remote device to perform a method of content presentation, said remote device including a display and a user interface, said method comprising the steps of:
receiving a media file, said media file comprising a content file, said content file including at least one of video data, graphics data, and audio data;
presenting the content file on the mobile communication device;
receiving from a user an input signal;
generating a notification signal in response to the input signal received; and
transmitting said notification signal.

31. The machine readable medium of claim 30, wherein said notification signal is generated only if said input signal is received from the user within a predetermined time period following the presentation of the content file.

32. The machine readable medium of claim 30, said method further comprising a step of displaying a plurality of graphical images in a periodic sequence, wherein each of said plurality of graphical images represent a period of time remaining.

33. The machine readable medium of claim 30, wherein said notification signal includes one of time and date upon which the content file was presented on said remote device.

34. The machine readable medium of claim 30, wherein said content file is executed immediately upon the media file being received by said remote device.

35. The machine readable medium of claim 30, wherein said remote device is a cellular phone.

36. The machine readable medium of claim 30, wherein said content file is one of an advertisement presentation, marketing survey, invitation to an offer, interactive media, and an electronic voucher for purchase of goods or services.

37. The machine readable medium of claim 36, wherein said method further comprises the step of, if the content file is one of a marketing survey, interactive media, or invitation to an offer, receiving from said remote device a user response to the marketing survey, interactive media, or the invitation to an offer.

38. The machine readable medium of claim 30, wherein said media file includes multimedia countdown data, said multimedia countdown data containing executable instructions for causing said remote device to indicate to the user of said remote device an expiring time period during which input signal from the user is to be received in order to generate said notification signal.

39. The machine readable medium of claim 30, wherein the notification signal is transmitted immediately after the remote device receives said input signal from the user.

40. The machine readable medium of claim 30, wherein the notification signal includes a location information, said location information indicating a location of the remote device at which the content file was presented.

41. The machine readable medium of claim 30,
wherein the media file includes code data that includes graphical data, said graphical data causing the remote device to display a graphical image representing one of an alpha, a numerical, and an alphanumerical code,
wherein the notification signal is sent only if the user code received from the user matches the code displayed in the graphical image.

42. The machine readable medium of claim 30,
wherein the media file includes code data for causing the remote device to generate an audio sound, said audio sound reciting one of an alpha, a numerical, and an alphanumerical code,
wherein the notification signal is sent only if the user code received from the user matches the code displayed in the graphical image.

43. The machine readable medium of claim 41 wherein said graphical image is displayed upon the completion of the presentation of the content file.

44. The machine readable medium of claim 42, wherein said audio sound is presented upon the completion of the presentation of the content file.

45. The machine readable medium of claim 30, wherein said media file further includes presentation timing data, said presentation timing data causing the content file to be presented on the remote device at a designated time.

46. The machine readable medium of claim 30, wherein the notification signal is transmitted over a wireless network.

47. The machine readable medium of claim 30, wherein the notification signal is transmitted over the Internet upon detection of the remote device being connected to the Internet.

48. The machine readable medium of claim 30, wherein the media file includes at least one network address that is selectable during the presentation of the content file on the remote device.

49. The machine readable medium of claim 48, wherein the selection of said at least one network address causes the remote device to automatically launch an Internet browser software that is already installed on the remote device.

50. The machine readable medium of claim 48, wherein said network address is a hypertext link.

51. The machine readable medium of claim 30, wherein the presentation of said content file is interruptible upon receiving an interrupt signal.

52. The machine readable medium of claim 51, wherein said interrupt signal is a pause signal.

53. The machine readable medium of claim 30,
wherein said media file further includes alternative content ending file and choice inquiry data,
wherein, at a predetermined point during which the content file is presented, the presentation of the content file is automatically interrupted, and the choice inquiry data causes the remote device to present an inquiry to the user of the remote device,
wherein, upon receiving from the user a choice signal, the media file causes the remote device to present the alternative content ending file, said alternative content ending file including one of video data, graphics data, and audio data.

54. A mobile phone, said mobile phone having a display and a user interface, said mobile phone having a programmed processor for performing a method comprising the steps of:
generating a display;
generating audio signals;
receiving a media file, said media file including a content file comprising one of a video data, graphics data, and audio data;
in response to presenting the content file, receiving from a user an input signal;
generating a notification signal in response to the input signal received; and
transmitting said notification signal.

55. The mobile phone of claim 54, wherein said notification signal is generated only if said input signal is received from the user within a predetermined time period following the presentation of the content file.

56. The mobile phone of claim 54, said method further comprising a step of displaying a plurality of graphical images in a periodic sequence, wherein each of said plurality of graphical images represent a period of time remaining.

57. The mobile phone of claim 54, wherein said notification signal includes one of time and date upon which the content file was presented on said mobile phone.

58. The mobile phone of claim 54, wherein said content file is executed immediately upon the media file being received by said mobile phone.

59. The mobile phone of claim 54, wherein said mobile phone is a cellular phone.

60. The mobile phone of claim 54, wherein said content file is one of an advertisement presentation, marketing survey, invitation to an offer, interactive media, and an electronic voucher for purchase of goods or services.

61. The mobile phone of claim 54, wherein said method further comprises the step of, if the content file is one of a marketing survey, interactive media, or invitation to an offer, receiving from said mobile phone a user response to the marketing survey, interactive media, or the invitation to an offer.

62. The mobile phone of claim 54, wherein said media file includes multimedia countdown data, said multimedia countdown data containing executable instructions for causing said mobile phone to indicate to the user of said mobile phone an expiring time period during which input signal from the user is to be received in order to generate said notification signal.

63. The mobile phone of claim 54, wherein the notification signal is transmitted immediately after the mobile phone receives said input signal from the user.

64. The mobile phone of claim 54, wherein the notification signal includes a location information, said location information indicating a location of the mobile phone at which the content file was presented.

65. The mobile phone of claim 54,
wherein the media file includes code data that includes graphical data, said graphical data causing the mobile phone to display a graphical image representing one of an alpha, a numerical, and an alphanumerical code,
wherein the notification signal is sent only if the user code received from the user matches the code displayed in the graphical image.

66. The mobile phone of claim 54,
wherein the media file includes code data for causing the mobile phone to generate an audio sound, said audio sound reciting one of an alpha, a numerical, and an alphanumerical code,
wherein the notification signal is sent only if the user code received from the user matches the code displayed in the graphical image.

67. The mobile phone of claim 65, wherein said graphical image is displayed upon the completion of the presentation of the content file.

68. The mobile phone of claim 66, wherein said audio sound is presented upon the completion of the presentation of the content file.

69. The mobile phone of claim 54, wherein said media file further includes presentation timing data, said presentation timing data causing the content file to be presented on the mobile phone at a designated time.

70. The mobile phone of claim 54, wherein the notification signal is transmitted over a wireless network.

71. The mobile phone of claim 54, wherein the notification signal is transmitted over the Internet upon detection of the mobile phone being connected to the Internet.

72. The machine mobile phone of claim 54, wherein the media file includes at least one network address that is selectable during the presentation of the content file on the mobile phone.

73. The mobile phone of claim 54, said method further comprising the step of, upon receiving a user selection of said at least one network address, cause the mobile phone to automatically launch an Internet browser software that is already installed on the mobile phone.

74. The mobile phone of claim 72, wherein said network address is a hypertext link.

75. The mobile phone of claim 54, wherein the presentation of said content file is interruptible upon receiving an interrupt signal.

76. The mobile phone of claim 75, wherein said interrupt signal is a pause signal.

77. The mobile phone of claim 54,
wherein said media file further includes alternative content ending file and choice inquiry data, said alternative content ending file including one of video data, graphics data, and audio data,
wherein said method further comprises the step of:
at a predetermined point during which the content file is presented, automatically interrupt the presentation of the content file,
cause the mobile phone to present an inquiry to the user,
upon receiving from the user a choice signal, present the alternative content ending file.

78. The method of claim 1, wherein said notification signal includes an identification information of the remote device.

79. The machine medium of claim 30, wherein said notification signal includes an identification information of the remote device.

80. The mobile phone of claim 54, wherein the notification signal includes an identification information of the mobile phone.
